(19) United States
(12) Patent Application Publication
(10) Pub. No.: US 2012/0002665 A1
(43) Pub. Date: Jan. 5, 2012

(54) Telephone Exchange Apparatus and Telephone Terminal and a Control Method Used for a Telephone System

(76) Inventor: Shingo Kimura, Hachioji-shi (JP)

(21) Appl. No.: 13/162,247

(22) Filed: Jun. 16, 2011

(30) Foreign Application Priority Data
Jun. 30, 2010 (JP) 2010-150345

(51) Int. Cl. H04L 12/66

(52) U.S. Cl. 370/352

(57) ABSTRACT

According to one embodiment, a telephone exchange apparatus includes a communication processor, a memory and a controller. The communication processor establishes a communication session between a plurality of telephone terminals on the private network and a telephone terminal on the global network through a common port specifying the private network. The memory stores a management table which associates a terminal ID specifying a telephone terminal to be connected, a session ID specifying a communication session, and an address and port ID specifying a network to be connected to the telephone terminal, for each session. The controller refers to the management table based on a session ID included in a communication packet, and sends instruction data to the communication processor to effect communication by the communication packet between telephone terminals establishing a communication session, based on a reference result of the management table.

### CROSS-REFERENCE TO RELATED APPLICATIONS

This application is based upon and claims the benefit of priority from Japanese Patent Application No. 2010-150345, filed Jun. 30, 2010; the entire contents of which are incorporated herein by reference.

### FIELD

Embodiments described herein relate generally to a telephone exchange apparatus which establishes a communication session between a telephone terminal connected to a global network such as Internet and a telephone terminal connected to a private network such as a local area network (LAN), and a telephone terminal connected to the telephone exchange apparatus and a control method used for a telephone system.

### BACKGROUND

An IP telephone system, which bidirectionally transmits and receives audio and video data as packet data in real time through an Internet protocol (IP), has become popular in recent years. In the IP telephone system, a plurality of IP telephone terminals belongs to a private network such as a local area network (LAN), a private network is connected to a global network such as a public network and Internet through a router, and multimedia data is transferred between the IP telephone terminals and between the IP telephone terminal and global network by converting the addresses by the router.

In the above system, the router has a network address translator (NAT) function. A NAT function converts a private address to a global address by using one IP address previously assigned to establish connection, sends a converted address as a source IP address, and converts a global address of a destination IP address supplied upon reception to a private address.

In the above system, when making an inquiry about an audio channel to be used by a terminal on a control channel is inquired during communication, an IP address and port number in a header area of a response packet are converted, but an IP address and port number used as an audio port in a data area of a packet are not converted by a NAT router. Thus, a terminal receiving the packet cannot specify a correct destination when returning audio data to the packet source by using the IP address and port number in the data area of the packet, and substantially fails to make communication.

It has been proposed to provide a repeater such as a media gateway in a private network for establishing an audio channel or a media session between a terminal on a global network and a terminal on a private network through the repeater. In this case, it is necessary to set a NAT router to transfer a port by the number of media sessions to be relayed at a time, and to set a firewall to permit input of an audio packet to a corresponding port. Further, as the number of simultaneously relayed sessions increases, the labor of a maintenance person in setting increases, many ports are permitted to pass through a firewall, and the security level decreases.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic diagram showing a configuration of a communication system according to a first embodiment;

FIG. 2 is a block diagram showing a configuration of a call control server according to the first embodiment;

FIG. 3A is a table showing an example of contents of a relay session management table shown in FIG. 2;

FIG. 3B is a table showing an example of contents of a relay session management table shown in FIG. 2;

FIG. 4 is a block diagram showing a configuration of an IP telephone set according to the first embodiment;

FIG. 5 is a diagram showing a structure of an RTP packet;

FIG. 6 is a sequence diagram for explaining transmission/reception of a control signal until communication is started between an IP telephone set on a LAN and an IP telephone set on an IP network;

FIG. 7 is a diagram for explaining the operation of a call control server until communication is started between an IP telephone set on a LAN and an IP telephone set on an IP network in the first embodiment;

FIG. 8 is a diagram for explaining the operation of a call control server when a media session is established between an IP telephone set on a LAN and an IP telephone set on an IP network in the first embodiment;

FIG. 9 is a block diagram for explaining the operation of an IP telephone set when a media session is established in the first embodiment;

FIG. 10 is a flowchart of the operation of an IP telephone set when a media session is started in the first embodiment;

FIG. 11 is a block diagram for explaining the operation of a media repeater when a media session is established in the first embodiment;

FIG. 12 is a sequence diagram for explaining the flow of a control signal and RTP packet until a media session is established between an IP telephone set on a LAN and an IP telephone set on an IP network in the first embodiment;

FIG. 13 is a block diagram showing a configuration of a call control server according to a second embodiment;

FIG. 14 is a sequence diagram for explaining transmission/reception of a control signal until a call is started between an IP telephone set on a LAN and an IP telephone set on an IP network in the second embodiment; and

FIG. 15 is a sequence diagram for explaining the flow of a control signal and RTP packet until a media session is established between an IP telephone set on a LAN and an IP telephone set on an IP network in the second embodiment.

### DETAILED DESCRIPTION

Various embodiments will be described hereinafter with reference to the accompanying drawings. In general, according to one embodiment, a telephone exchange apparatus includes a communication processor, a memory and a controller. The communication processor establishes a communication session between a plurality of telephone terminals on the private network and a telephone terminal on the global network through a common port specifying the private network. The memory stores a management table which associates a terminal ID specifying a telephone terminal to be connected, a session ID specifying a communication session, and an address and port ID specifying a network to be connected to the telephone terminal, for each session, when a communication session is established by the communication processor. The controller refers to the management table based on a session ID included in a communication packet when a communication packet is received, and sends instruction data to the communication processor to effect communication by the communication packet between telephone terminals establishing a communication session, based on a reference result of the management table.

### First Embodiment

A first embodiment solves a problem that communication fails when a NAT router intervenes in a communication session between IP telephone terminals. Following technologies are known as systems to solve the problem.

(Application Layered Gateway (ALG) System)

A NAT router rewrites a private address in a specific protocol to its own global address, and transfers the global address. Applicable protocols are limited, and characteristics of a NAT router vary with vendors, and cannot timely follow expansion of a protocol.

(STUN System)

A NAT router can know a converted port number by sending a packet once from an IP endpoint behind a NAT router to a STUN server provided on a global network. A device equivalent to a STUN server must be provided on a global network. This is inapplicable to a NAT system called a symmetric system employed in many routers for corporations.

(TURN System)

Communication is possible without a NAT router system, by using a TURN server provided on a global network for transmission from an IP endpoint behind a NAT router.

(uPnP System)

An IP address and port number after conversion are inquired by a NAT router supporting a protocol called uPnP, and a media session is established by using the obtained data. This is not supported by a router designed for a corporation.

In the first embodiment, the above TURN system is employed, a call control server is provided on a private network as a TURN server, and a large number of media relay sessions is multiplexed at a single or a few ports.

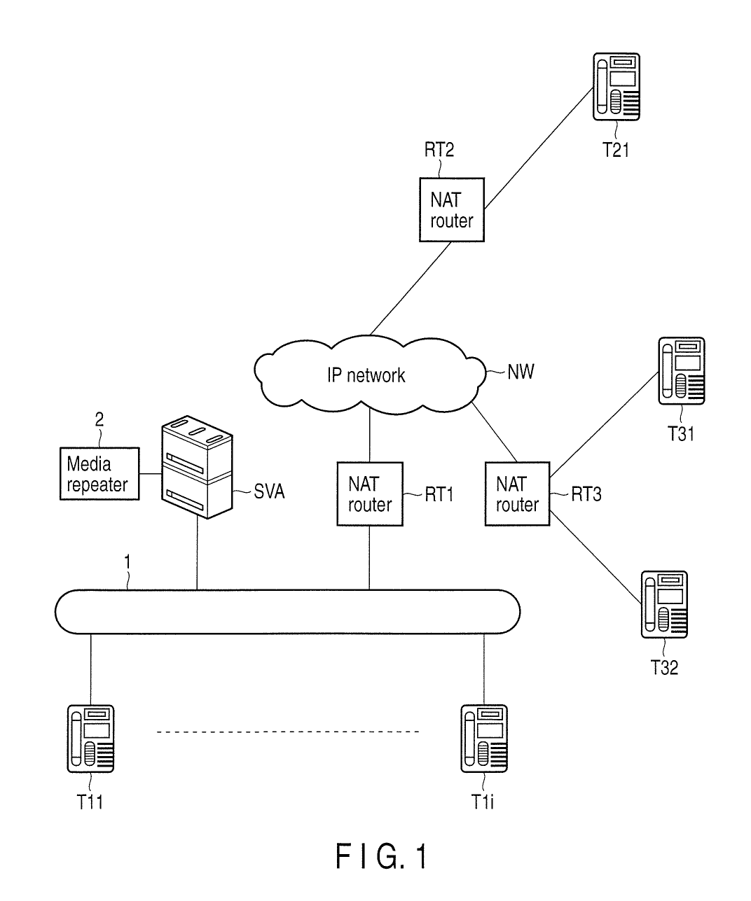

FIG. 1 is a schematic diagram showing a configuration of a communication system according to a first embodiment.

The system has a local area network (LAN) 1 as a private network. The LAN 1 is connected to a plurality of IP telephone sets T11 to T1i (i: a natural number) as telephone terminals. The IP telephone sets T11 to T1i are terminals including a call processing function and a media data processing function. The LAN 1 comprises a plurality of media channels, and a control channel to transmit a control signal necessary to determine the media channel.

The LAN 1 is connected to a NAT router RT1, and a call control server SVA as a telephone exchange apparatus. The NAT router RT1 includes a function of converting an address between the LAN 1 and IP network NW as a global network, and is set to pass a predetermined service packet only from the IP network NW to LAN 1.

The IP network NW is connected to NAT routers RT2 and RT3. The NAT router RT2 is connected to an IP telephone set T21. The NAT router RT3 is connected to IP telephone sets T31 and T32. The IP telephone sets T21, T31, and T32 are terminals including a call processing function and a media data processing function.

The call control server SVA includes an exchange control function to establish a session according to a SIP, for example, between the IP telephone sets T11 to T1i, or between the IP telephone sets T11 to T1i and the IP telephone sets T21, T31 and T32 on the IP network NW. After establishing a session, the server SVA executes voice communication by transmitting/receiving an RTP packet in peer-to-peer fashion between the telephone sets on the source and destination sides.

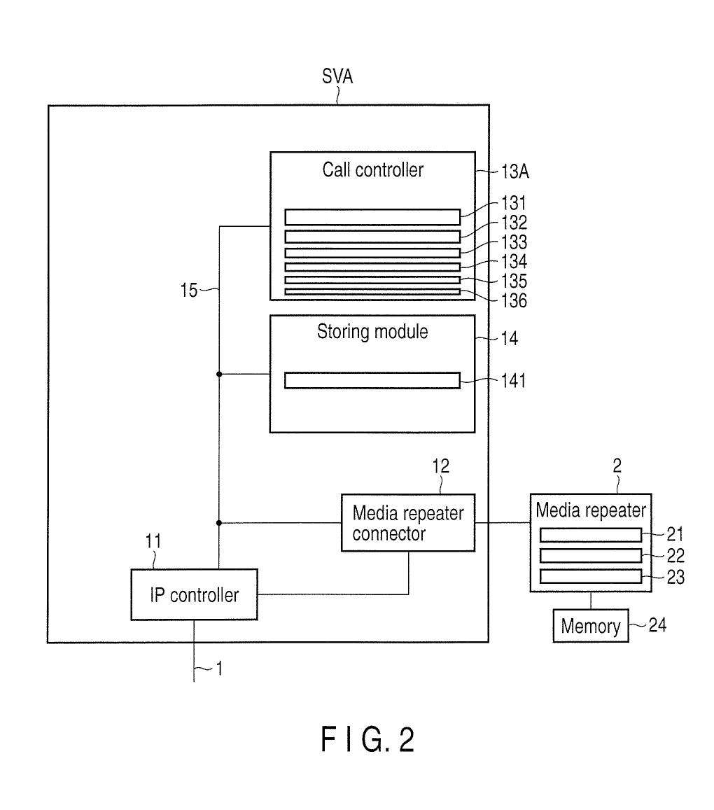

The above call control server SVA includes the following functions in the first embodiment. FIG. 2 is a block diagram showing the configuration of the call control server SVA.

The call control server SVA comprises an IP controller 11, a media repeater connector 12 (a connector 12), a call controller 13A, and a memory 14. The IP controller 11, media repeater connector 12, call controller 13A, and memory 14 are connected through a data highway 15.

The IP controller 11 is connected to the LAN 1 if necessary. The IP controller 11 interfaces with the LAN 1 connected. The IP controller 11 transfers various control data about the interface with the call controller 13A through the data highway 15.

The media repeater 2 is connected to the connector 12. The media repeater 2 establishes a communication session between the IP telephone sets T11 to T1i on the LAN 1 and the IP telephone sets T21, T31 and T32 on the IP network NW through a common port (No. 49152) specifying the LAN 1. The media repeater 2 processes a control message and RTP packet received by the IP controller 11.

The call controller 13A comprises a CPU, a ROM, and a RAM, and controls each part of the call control server SVA by software processing.

The memory 14 stores routing data necessary for connection control of the call controller 13A. The routing data associates the telephone numbers previously assigned to the IP telephone sets T11 to T1i, T21, T31 and T32 as identification data, with IP addresses as variable network addresses.

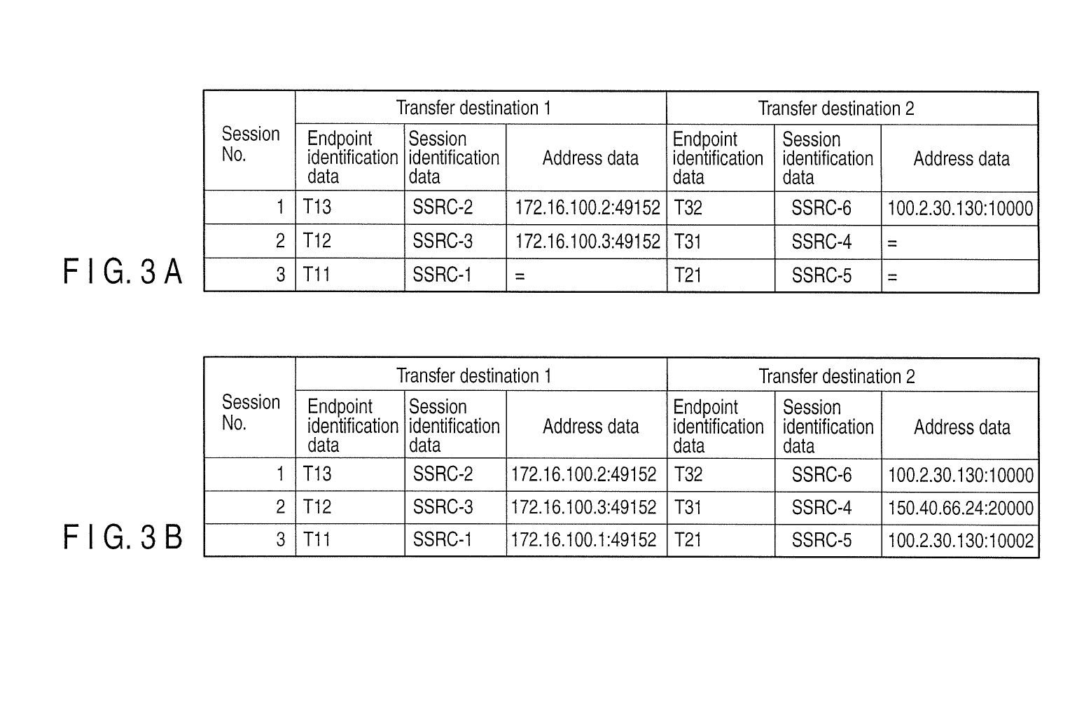

The memory 14 includes a relay session management table 141 (a table 141). The table 141 is registered by the call controller 13 to manage the IP telephone sets T11 to T1i, T21, T31 and T32 for which a communication session has been established, as shown in FIGS. 3A and 3B. The table 141 associates endpoint identification data as terminal IDs previously assigned to IP telephone sets T11 to T1i, T21, T31 and T32 connected to the call control server SVA for each session, session identification data as session ID, and address data. The session identification data is included in a header of an RTP packet, and identifies an established communication session. The address data consists of an IP address and port number to specify a network to which an IP telephone set is connected.

The call controller 13A comprises an endpoint control signal transmitter/receiver 131 (a transmitter/receiver 131), a session identification data notice processor 132 (a notice processor 132), a session identifier collating module 133 (a collating module 133), a session identification data notice responding module 134 (a responding module 134), a relay session start/stop instructing module 135 (an instructing module 135), and a media relay control signal transmitter/receiver 136 (a transmitter/receiver 136).

The transmitter/receiver 131 transmits/receives a control signal to/from each IP telephone set, when a communication session is established between IP telephone sets. The notice processor 132 extracts session identification data from a control signal, and requests the collating module 133 to collate the data.

The collating module 133 refers to the relay session management table 141, and determines whether any one of the sessions under relaying has the same session identification data, and returns the result to the notice processor 132.

The responding module 134 generates a control signal for acknowledgement or negative acknowledgement based on the determination result, and sends the transmitter/receiver 131 a transmission instruction together with data about a destination IP telephone set.

The instructing module 135 registers a session number, IP telephone data, and a session identifier in the management table 141, and generates a media relay start instruction including these data.

The transmitter/receiver 136 sends the above start instruction signal to the media repeater 2.

The media repeater 2 comprises a control signal transmitter/receiver 21 (a transmitter/receiver 21), a media relay controller 22 (a controller 22), a media repeating module 23, and a memory 24. The transmitter/receiver 21 transmit/receives a control signal to/from the call control server SVA. The controller 22 receives a signal concerning a media relay from the transmitter/receiver 21, and provides the media repeating module 23 with an instruction to start/stop media relay and necessary data.

According to the instruction of the controller 22, the media repeating module 23 processes an RTP packet communicated among the IP telephone sets T11 to T1i, T21, T31 and T32 for which a communication session is established.

The memory 24 stores the same memory data as that stored in the management table 141 transferred from the call control server SVA.

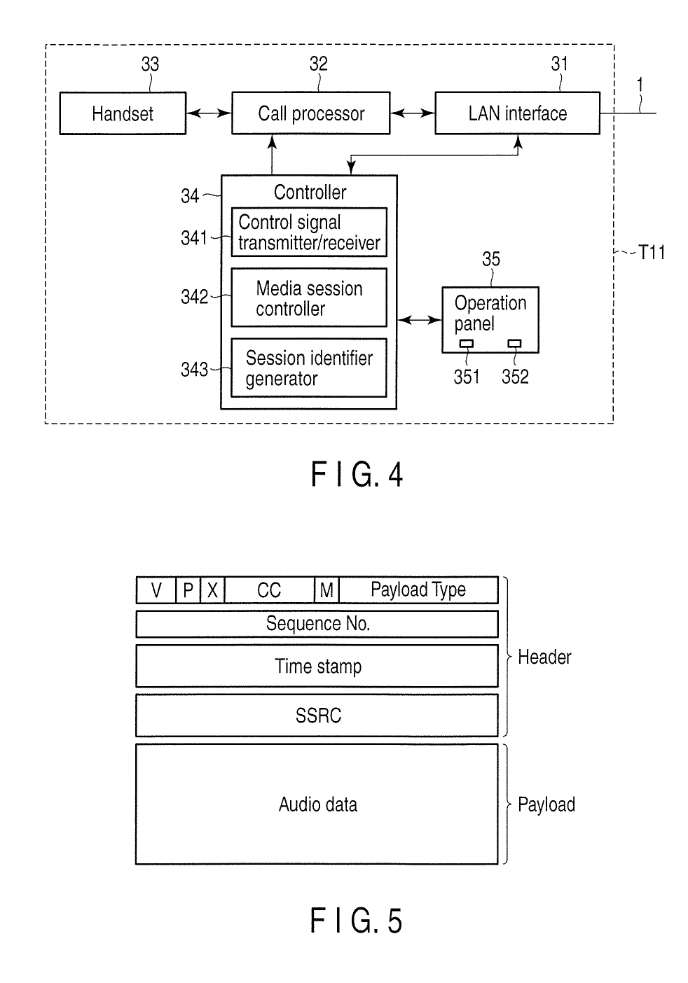

FIG. 4 is a block diagram showing the configuration of the IP telephone sets T11 to T1i, T21, T31 and T32. The IP telephone set T11 is explained as an example.

In FIG. 4, the IP telephone set T11 comprises a LAN interface 31, a call processor 32, a handset 33, a controller 34, and an operation panel 35.

The LAN interface 31 transfers various data with the LAN 1 by transmission. The LAN interface 31 sends the call processor 32 an RTP packet sent from the LAN 1. The LAN interface 31 generates a transmission signal by time sharing and multiplexing a serial data signal sent from the call processor 32 and controller 34, and sends it to the LAN 1 as an RTP packet.

The call processor 32 takes out the call data included in the RTP packet sent from the LAN interface 31, and reproduces a received analog audio signal from the call data. The call processor 32 drives a receiver of the handset 33 by the reproduced received audio signal, and outputs the received audio signal. The call processor 32 receives a transmitted analog audio signal generated by a transmitter of the handset 33. The call processor 32 converts the transmitted audio signal to an RTP packet, and sends it to the LAN interface 31.

The controller 34 comprises a CPU, a ROM, and a RAM, and controls each part of the IP telephone set T11 by software processing.

The operation panel 35 comprises a displaying module 351 such as a liquid crystal display (LCD), and an input keypad 352. The displaying module 351 displays various data indicating operations for example a telephone directory.

The controller 34 comprises a control signal transmitter/receiver 341 (a transmitter/receiver 341), a media session controller 342, and a session identifier generator 343 (a generator 343). The transmitter/receiver 341 transmits/receives a control signal to/from the call control server SVA.

The media session controller 342 sends the generator 343 an instruction to generate session identification data, when a session is started based on a control signal received from the transmitter/receiver 341, and causes the call processor 32 to send/receive an RTP packet including a session identifier, when a session has been established.

The generator 343 randomly generates an identifier (a synchronization source identifier (SSRC)) to be inserted into a header of an RTP packet, according to an instruction from the media session controller 342. A new identifier is generated whenever a session is established. As shown in FIG. 5, an RTP packet consists of a header and a payload. A header stores version data indicating a packet type, data (P) indicating the existence or absence of padding data, data (X) indicating the presence or absence of an extension header, data (CC) indicating a communication format such as two-way and three-way, data indicating the presence or absence of a marker, and a payload type. A header comprises a sequence number indicating the order of transmitting an RTP packet, a time stamp indicating the time to transmit an RTP packet, and an SSRC.

A payload stores digital audio data encoded by a codec such as G.722, G.723, G.728 and G.729.

Next, the operation with the above configuration will be explained.

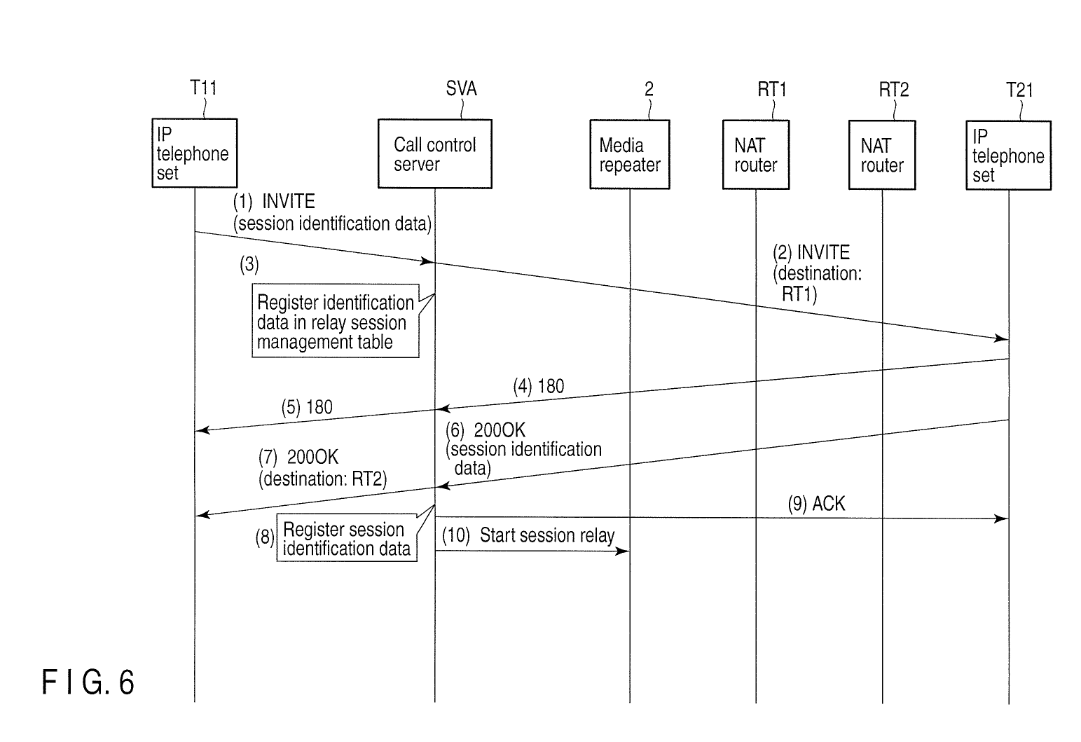

FIG. 6 is a sequence diagram for explaining transmission/reception of a control signal until communication is started between the IP telephone sets T11 and T21. Here, a session initiation protocol (SIP) is explained as an example.

When the user of the IP telephone set T11 originates a call to the IP telephone set T21, a call message (INVITE message) is sent from the IP telephone set T11 to the call control server SVA (FIG. 6, (1)).

Receiving the call message, the call control server SVA generates an INVITE message designating the NAT router RT1 as a transmission source, and sends it to the IP telephone set T21 (FIG. 6, (2)). Then, the call control server SVA associates the endpoint identification data about the IP telephone set T11 and session identification data with a session number 3, and registers the data in the management table 141 (FIG. 6, (3)).

On the other hand, when the incoming call is acknowledged, the IP telephone set T21 sends an acknowledgement message (180) to the call control server SVA (FIG. 6, (4)). The call control server SVA sends the acknowledgement message (180) to the source IP telephone set T11 (FIG. 6, (5)).

The IP telephone set T21 sends an acknowledgement message with session identification data added (200OK) to the call control server SVA (FIG. 6, (6)). Receiving the acknowledgement message (200OK), the call control server SVA generates an acknowledgement message designating the NAT router RT2 as a transmission source (200OK), and sends it to the IP telephone set T11 (FIG. 6, (7)). Then, the call control server SVA associates the endpoint identification data about the IP telephone set T21 and session identification data with a session number 3, and registers the data in the management table 141 (FIG. 6, (8)).

Thereafter, the call control server SVA sends back an acknowledgement (ACK) to the IP telephone set T21 (FIG. 6, (9)), and instructs the media repeater 2 to start relaying a session including data stored in the management table 141 (FIG. 6, (10)).

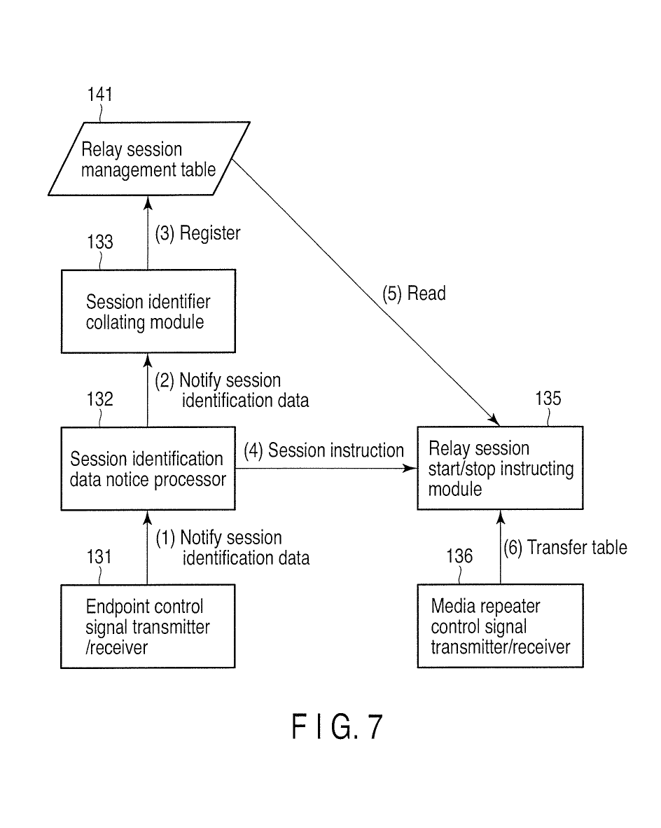

FIG. 7 is a diagram for explaining the operation of the call control server SVA until communication is started between the IP telephone sets T11 and T21.

In the call control server SVA, when the transmitter/receiver 131 receives a call message (FIG. 7, (1)), the notice processor 132 notifies the collating module 133 of the endpoint identification data about the source IP telephone set T11 and session identification data (FIG. 7, (2)), associates the endpoint identification data about the IP telephone set T11 and session identification data with a session number 3, and registers the data in the management table 141 (FIG. 7, (3)). The management table 141 stores the IP address and port number assigned to the IP telephone set T11 as address data.

When the transmitter/receiver 131 receives an acknowledgement message, the notice processor 132 notifies the collating module 133 of the endpoint identification data about the destination IP telephone set T21 and session identification data, associates the endpoint identification data about the IP telephone set T21 and session identification data with a session number 3, and registers the data in the management table 141. The management table 141 stores the IP address and port number assigned to the IP telephone set T11 as address data. The management table 141 stores the IP address and port number assigned to the NAT router RT2 to which the IP telephone set T21 belongs, as address data.

Thereafter, the notice processor 132 sends a session start instruction to the instructing module 135 (FIG. 7, (4)), and causes the instructing module 135 to read the endpoint identification data and session data about the IP telephone sets T11 and T21 associated with the session number 3 (FIG. 7, (5)). The instructing module 135 instructs the transmitter/receiver 136 to transfer the read data to the media repeater 2 (FIG. 7, (6)).

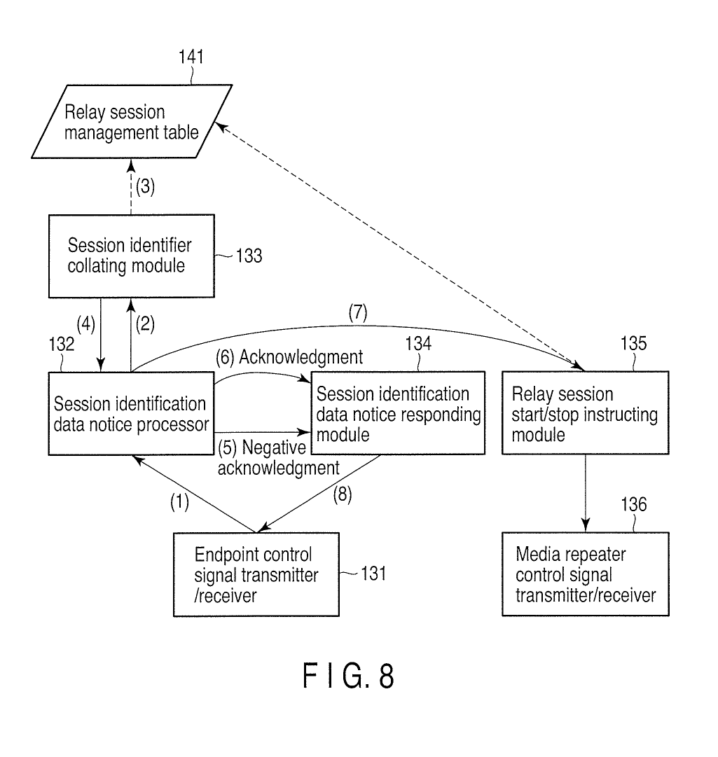

FIG. 8 is a diagram for explaining the operation of the call control server SVA when a media session is established between the IP telephone sets T11 and T21.

When a media session is established between two IP telephone sets, if a call is made between IP telephone sets of different sides through the NAT routers RT1, RT2 and RT3, the call control server SVA instructs the IP telephone sets to establish a media session through the media repeater 2.

In the call control server SVA, the transmitter/receiver 131 receives a control signal from the IP telephone sets T11 and T21, and sends the signal to different software blocks according to the kinds of the signal. When the received control signal is a media session identification data notice, the signal is sent to the notice processor 132 (FIG. 8, (1)).

The notice processor 132 extracts session identification data from a control signal, and requests the collating module 133 to collate the data (FIG. 8, (2)). The collating module 133 refers to the management table 141 (FIG. 8, (3)), determines whether any one of sessions under relaying has the same session identification data, and returns the result to the notice processor 132 (FIG. 8, (4)).

When any one of the sessions has the same session identification data, the notice processor 132 instructs the responding module 134 to send a negative acknowledgment (FIG. 8, (5)). When no sessions has the same session identification data, the notice processor 132 instructs the responding module 134 to send an acknowledgement (FIG. 8, (6)), and instructs the instructing module 135 to start relaying the media session associated with the media repeater 2 by the corresponding session identification data (FIG. 8, (7)).

The responding module 134 generates a control signal for an acknowledgement or negative acknowledgement according to the instruction, and sends the transmitter/receiver 131 a transmission instruction together with data about a destination IP telephone set (FIG. 8, (8)). The instructing module 135 registers a session number, IP telephone data, and a session identifier in the management table 141, and generates a media relay start instruction including these data. Finally, the transmitter/receiver 136 sends the start instruction signal to the media repeater 2.

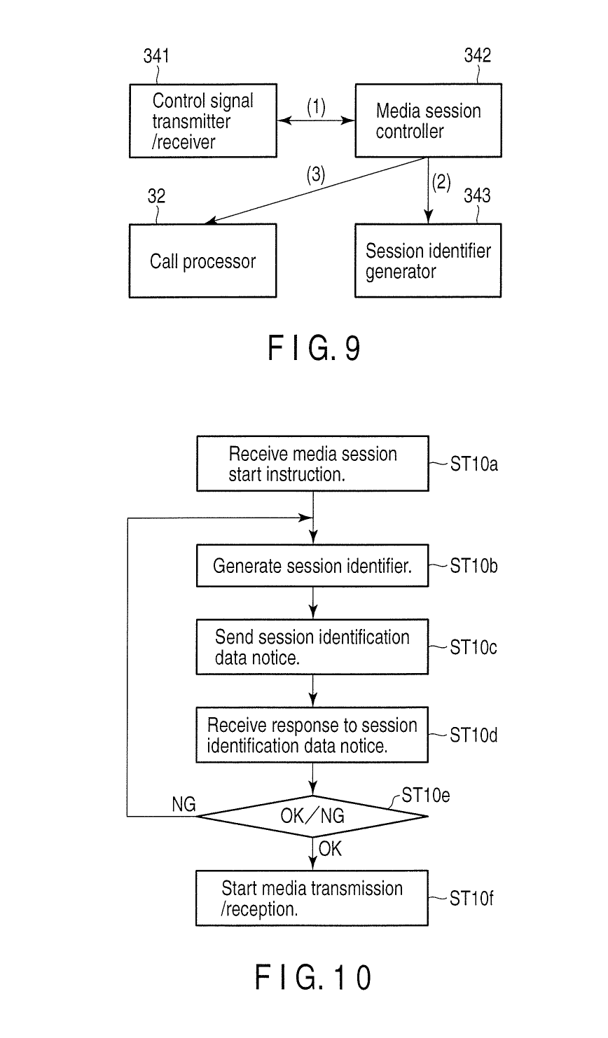

FIG. 9 is a block diagram for explaining the operation of the IP telephone set T11 when a media session is established.

A control signal concerning the control of a media session received by the transmitter/receiver 341 is notified to the media session controller 342 (FIG. 9, (1)). The generator 343 randomly generates session identification data according to the instruction from the media session controller 342, and generates the same session identification data until a call is finished (FIG. 9, (2)). The call processor 32 starts transmission/reception of an RTP packet including session identification data according to the instruction from the media session controller 342 (FIG. 9, (3)).

FIG. 10 is a flowchart of the operation of the IP telephone set T11 when a media session is started.

When the media session controller 342 receives a media session start instruction (block ST10a), the controller 34 of the IP telephone set T11 instructs the generator 343 to generate session identification data (SSRC) (block ST10b).

Then, the controller 34 generates a session identification data notice signal including the identification data, and instructs the transmitter/receiver 341 to transmit the signal (block ST10c). Receiving a response to the session identification data notice (block ST10d), the controller 34 determines whether the noticed identification data is accepted (ACK) or refused (NAK) (block ST10e). When the identification data is accepted, the controller 34 instructs the call processor 32 to transmit an RTP packet including the identification data (block ST10f).

When the identification data is refused, the controller 34 instructs again the generator 343 to generate identification data different from the previous one, and transmits the new identification data to the call control server SVA (blocks ST10b and ST10c).

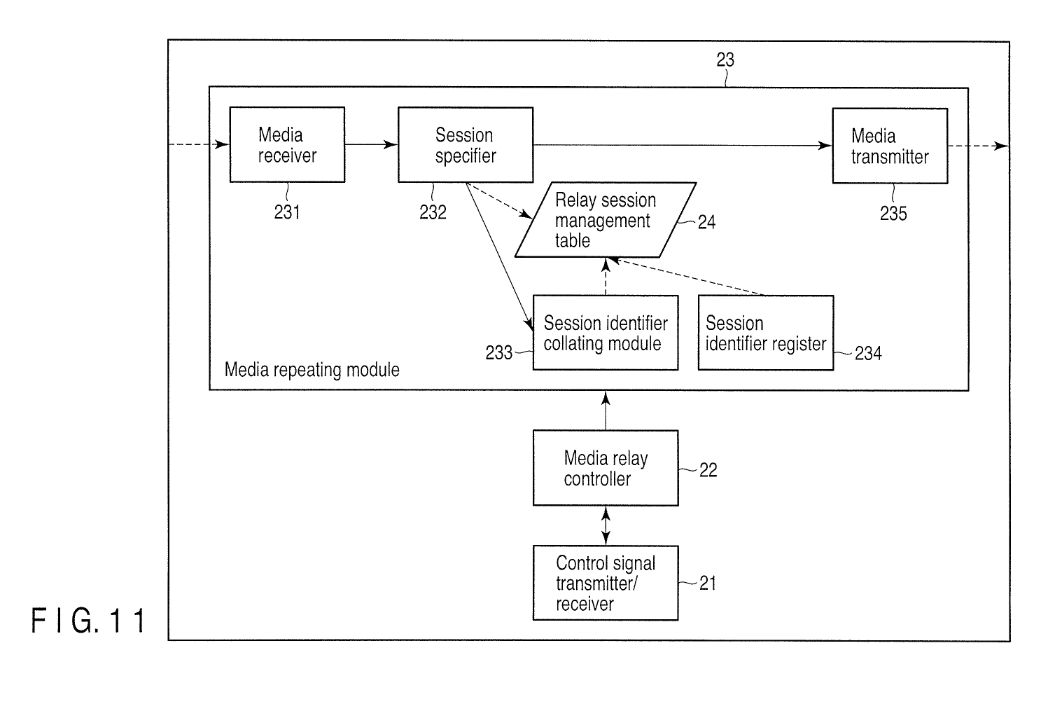

FIG. 11 is a block diagram for explaining the operation of the media repeater 2 when a media session is established.

The transmitter/receiver 21 transfers a control signal with the call control server SVA. The controller 22 receives a signal concerning a media relay from the transmitter/receiver 21, and instructs the media repeating module 23 to start or stop the media relay, and provides necessary information. In the media repeating module 23, the media receiver 231 receives an RTP packet from the LAN 1, and notifies the session specifier 232 of the received packet and its source address (IP address and port number).

The session address specifier 232 refers to the relay session management table stored in the memory 24, and specifies a relay destination address from a source address. At this time, the session specifier 232 requests the collating module 233 to collate the data. The collating module 233 refers to the relay session management table in the memory 24, determines whether any one of the sessions under relaying has the same session identification data, and returns the result to the session specifier 232.

If the source address is registered in the management table and a corresponding relay destination address is present, the session specifier 232 sends the received packet and relay destination address to the media transmitter/receiver 235, and requests the media transmitter/receiver to transmit (relay) the packet.

In the media repeating module 23, when endpoint identification data and session identification data about the IP telephone set to establish a media session are received from the call controller SVA at the start of media relay, the register 234 associates the endpoint identification data and session identification data about the IP telephone set with a corresponding session number, and stores the data in the memory 24.

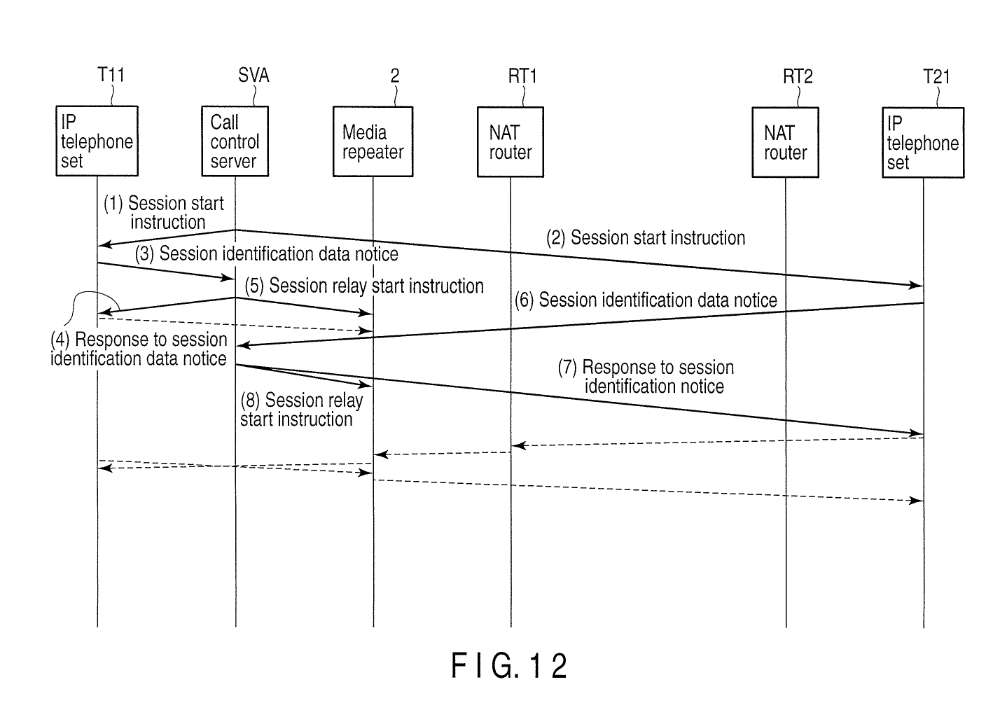

FIG. 12 is a sequence diagram for explaining the flow of control signal and RTP packet until a media session is established between the IP telephone sets T11 and T21.

The call control server SVA sends a session start instruction to the IP telephone sets T11 and T21 (FIG. 12, (1) and (2)). Receiving the session start instruction, the IP telephone set T11 generates session identification data, and sends a session identification data notice to the call control server SVA (FIG. 12, (3)).

The call control server SVA collates the session identification data included in the session identification data notice, sends the IP telephone set T11 a response accepting the use of the identification data to the session identification data notice (FIG. 12, (4)), and sends the media repeater 2 a relay start instruction including the accepted session identification data (SSRC-1) (FIG. 12, (5)). Immediately after the use of a session identifier is accepted by the response to the session identification data notice, the IP telephone set T11 starts sending an RTP packet to the media repeater 2.

Receiving the session start instruction, the IP telephone set T21 generates session identification data, and sends a session identification data notice to the call control server SVA (FIG. 12, (6)).

The call control server SVA collates the session identification data included in the session identification data notice, sends the IP telephone set T21 a response accepting the use of the identification data to the session identification data notice (FIG. 12, (7)), and sends the media repeater 2 a relay start instruction including the accepted session identification data (SSRC-5) (FIG. 12, (8)). Immediately after the use of a session identifier is accepted by the response to the session identification data notice, the IP telephone set T21 starts sending an RTP packet to the media repeater 2.

The media repeater 2 registers the session identification data included in the session relay start instruction in the internal management table, and wits for an RTP packet. When an RTP packet is received from both IP telephone sets T11 and T21, the relay destination telephone sets T11 and T21 can be connected by the session identification data, and a two-way media relay is completed.

The IP telephone set T11 sends an RTP packet to the NAT router RT2, which becomes a transmission source notified by the call control server SVA at the start of session. The IP telephone set T21 sends an RTP packet to the NAT router RT1, which becomes a transmission source notified by the call control server SVA at the start of session. This enables voice communication between the source IP telephone set T11 and destination IP telephone set T21.

Therefore, even if two or more above-mentioned session relays occur at a time, and the number of ports to transfer an RTP packet on the media repeater 2 is fixed to one, the IP telephone sets at both ends of a session can be connected by following the above described procedure.

Further, the media repeater 2 holds data about the transfer destinations at both ends at each session. The held data comprises endpoint identification data, session identification data, and address data. The endpoint identification data is an extension number of an IP telephone set, for example. The endpoint identification data and session identification data are included in a session start instruction signal received from the call control server SVA. When an RTP packet is received and its session identification data coincides, the source IP address and port number of the RTP packet are recorded as address data.

FIG. 3A shows that all relay session data on both sides are defined for a media session between the IP telephone sets T12 and T32, and a session is bidirectionally relayed, but a transfer address to the IP telephone set T31 is not defined for a media session between the IP telephone sets T12 and T31, and a transfer address to both sides is not defined for a media session between the IP telephone sets T11 and T21. When time elapses and an RTP packet is received from all IP telephone sets, the management table is updated as shown in FIG. 3B, and a two-way relay is possible for all three sessions.

As described above, in the first embodiment, the call control server SVA uses a common port (No. 49152) for the IP telephone sets T11, T12 and T13 on the LAN 1, which establish a media session with the IP telephone sets T21, T31 and T32 on the IP network NW. When a media session is established, the call control server SVA stores and manages the management table 141, which associates endpoint identification data specifying the connected IP telephone sets T11 and T21, session identification data specifying a media session, and IP address and port number, for each session. When an RTP packet is received, the call control server SVA uses the session identification data included in the header of the RTP packet, and sends a session start instruction to the media repeater 2 to make an RTP packet communication between the IP telephone sets T11 and T21 between which a media session is established.

Therefore, it is unnecessary to set a transfer port of all IP telephone sets T11 to T1i on the LAN 1 for the NAT router RT1, and at least one transport may be set. Further, by using the management table 141, an RTP packet destination can be specified from the session identification data included in an RTP packet, and communication is possible between the IP telephone sets T11 to T1i on the LAN 1 and IP network NW, even if a media session is requested from the IP telephone sets T11 to T1i in the same time period, without decreasing the security level of LAN 1.

Further, in the first embodiment, the IP telephone sets T11 to T1i, T21, T31 and T32 are configured to notify the call control server SVA session identification data specifying a media session by means of an existing control signal such as an INVITE message, and enables communication by a media session between the IP telephone set T11 on the LAN 1 and the IP telephone set T21 on the IP network NW. Therefore, it is unnecessary to newly provide a signal to notify session identification data, and communication is simply executed.

### Second Embodiment

In the second embodiment, a call controller intensively generates unique session identification data, and instructs a corresponding IP telephone set to use appropriate session identification data when a media session is started.

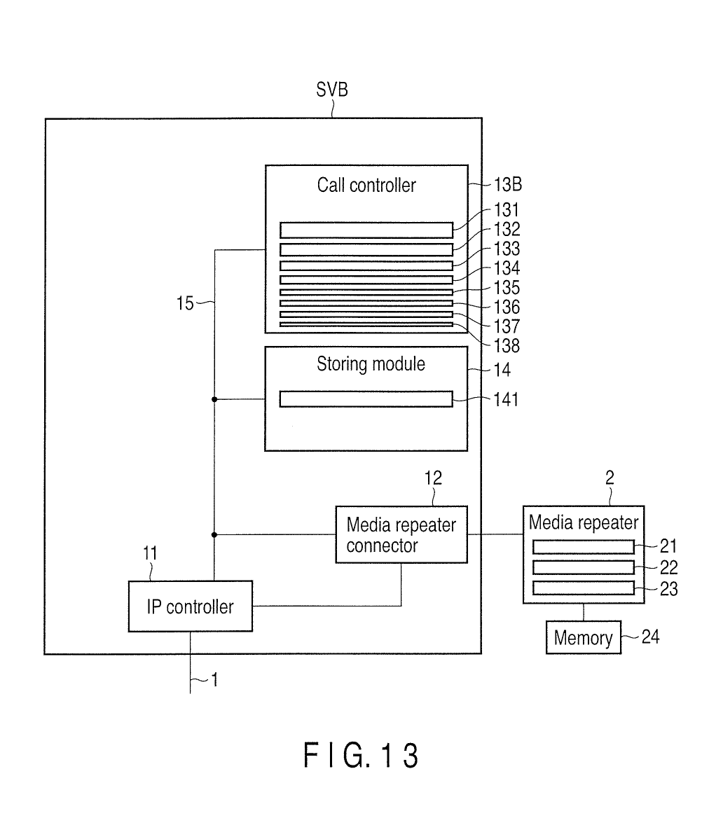

FIG. 13 is a block diagram showing a configuration of a call control server SVB according to a second embodiment. In FIG. 13, the same parts as those in FIG. 2 are given the same reference numbers, and a detailed explanation thereof is omitted.

A call controller 13B comprises a session identification generator 137 (a generator 137), and a session identification data notifying module 138 (a notifying module 138). The generator 137 generates session identification data to be inserted into a header of an RTP packet at the start of media session. Whenever a media session is established, session identification data is generated and given a different number.

The notifying module 138 notifies the IP telephone sets T11 and T21 to establish a media session of the session identification data generated by the generator 137.

The operation with the above configuration will be explained.

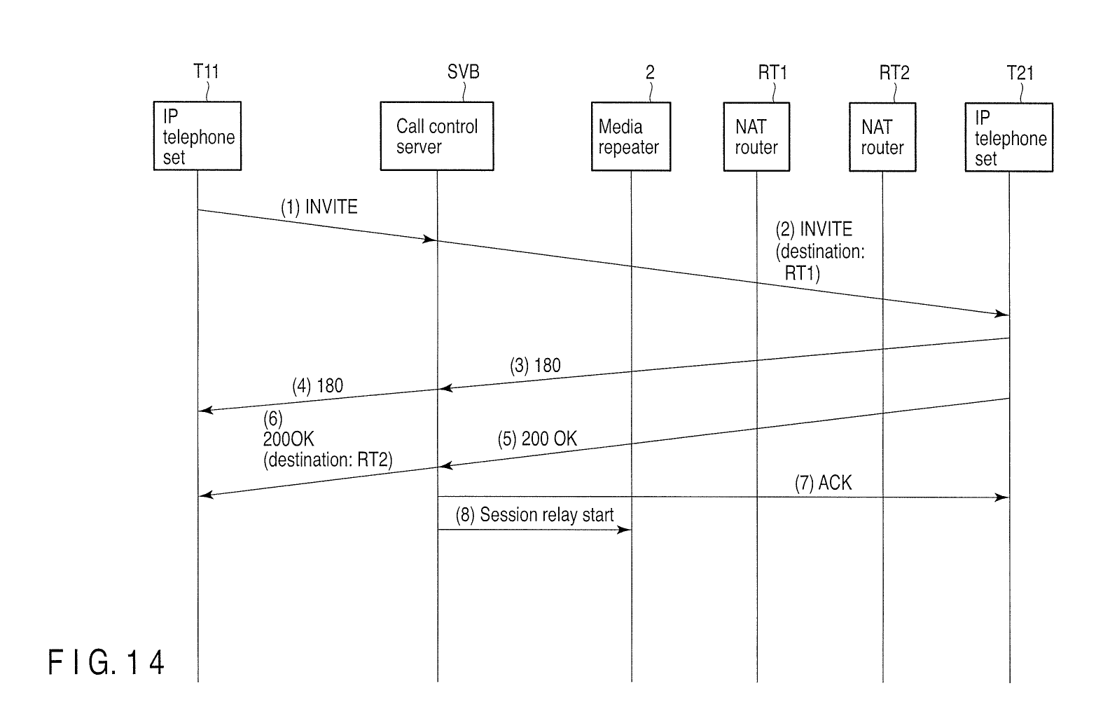

FIG. 14 is a sequence diagram for explaining transmission/reception of a control signal until communication is started between IP telephone sets T11 and T21 in the second embodiment. Here, a session initiation protocol (SIP) is explained as an example.

When the user of the IP telephone set T11 originates a call to the IP telephone set T21, a call message (INVITE message) is sent from the IP telephone set T11 to the call control server SVB (FIG. 14, (1)).

Receiving the call message, the call control server SVB generates an INVITE message designating the NAT router RT1 as a transmission source, and sends it to the IP telephone set T21 (FIG. 14, (2)).

When the incoming call is acknowledged, the IP telephone set T21 sends an acknowledgement message (180) to the call control server SVB (FIG. 14, (3)). The call control server SVB sends an acknowledgement message (180) to the source IP telephone set T11 (FIG. 14, (4)).

The IP telephone set T21 sends an acknowledgement message (200OK) to the call control server SVB (FIG. 14, (5)). Receiving the acknowledgement message (200OK), the call control server SVB generates an acknowledgement message designating the NAT router RT2 as a transmission source (200OK), and sends it to the IP telephone set T11 (FIG. 14, (6)).

Thereafter, the call control server SVB sends back an acknowledgement (ACK) to the IP telephone set T21 (FIG. 14, (7)), and instructs the media repeater 2 to start relaying a session including the data stored in the management table 141 (FIG. 14, (8)).

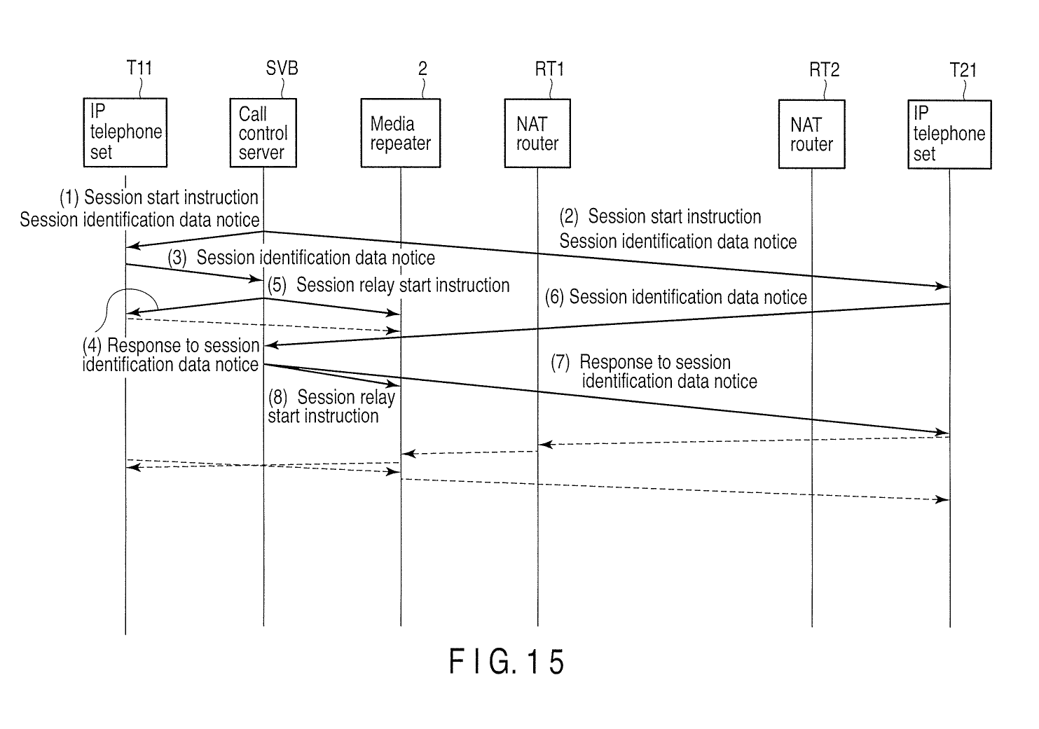

FIG. 15 is a sequence diagram for explaining the flow of control signal and RTP packet until a media session is established between the IP telephone sets T11 and T21 in the second embodiment.

The call control server SVB sends a session start instruction to the IP telephone sets T11 and T21 (FIG. 15, (1) and (2)), and notifies session identification data permitted to use. Receiving the session start instruction, the IP telephone set T11 sends the session identification data notice permitted to use to the call control server SVB (FIG. 15, (3)).

The call control server SVB collates the session identification data included in the session identification data notice, sends the IP telephone set T11 a response accepting the use of the identification data to a session identification data notice (FIG. 15, (4)), and sends the media repeater 2 a relay start instruction including the accepted session identification data (SSRC-1) (FIG. 15, (5)). Immediately after the use of a session identifier is accepted by the response to the session identification data notice, the IP telephone set T11 starts sending an RTP packet to the media repeater 2.

Receiving the session start instruction, the IP telephone set T21 sends a session identification data notice permitted to use to the call control server SVB (FIG. 15, (6)).

The call control server SVB collates the session identification data included in the session identification data notice, sends the IP telephone set T21 a response accepting the use of the identification data to the session identification data notice (FIG. 15, (7)), and sends the media repeater 2 a relay start instruction including the accepted session identification data (SSRC-5) (FIG. 15, (8)). Immediately after the use of a session identifier is accepted by the response to the session identification data notice, the IP telephone set T21 starts sending an RTP packet to the media repeater 2.

As described above, in the second embodiment, the call control server SVB is configured to generate session identification data, and notifies it to an IP telephone set to establish a media session. Therefore, even if a function of generating session identification data is not provided, when a session is requested from the IP telephone sets T11 to T1i on the LAN 1 in the same time period, communication is possible between an IP telephone set T11 on the LAN 1 and an IP telephone set T21 on the IP network NW, without decreasing the security level of LAN 1.

### Other Embodiments

A call control server and media repeater can be provided as different programs in the same apparatus, even if they are connected to a LAN as independent separate apparatuses.

An IP telephone set may issue an identification number and transmit it to a call control server immediately after or during establishment of a media session, as well as immediately before a media session is established. In this case, the issued identification number is managed as a number used for the next media session.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A telephone exchange apparatus which is connectable to a network address translator (NAT) router through a private network, and establishes a communication session between telephone terminals, wherein the NAT router establishes connection between a private network connected to the telephone terminals and a global network provided in a wider area than the private network and connected to the telephone terminals, comprising:
a communication processor configured to establish a communication session between a plurality of telephone terminals on the private network and a telephone terminal on the global network through a common port specifying the private network;
a memory configured to store a management table which associates a terminal ID specifying a telephone terminal to be connected, a session ID specifying a communication session, and an address and port ID specifying a network to be connected to the telephone terminal, for each session, when a communication session is established by the communication processor; and
a controller configured to refer to the management table based on a session ID included in a communication packet when a communication packet is received, and to send instruction data to the communication processor to effect communication by the communication packet between telephone terminals establishing a communication session, based on a reference result of the management table.

2. The telephone exchange apparatus of claim 1, wherein the controller determines whether a session ID included in a received communication packet is identical to a session ID in the management table, and sends instruction data to the communication processor to effect communication by the communication packet between telephone terminals establishing a communication session corresponding to the session ID when they are identical, and sends a message refusing reception of the communication packet to a telephone terminal which is a transmission source of the communication packet when they are not identical.

3. The telephone exchange apparatus of claim 1, wherein the controller extracts a session ID included in a header area of the communication packet, when the communication packet comprises the header area and a data area.

4. The telephone exchange apparatus of claim 1, further comprising a generator configured to generate a session ID when a communication session is established, and a notifying module configured to notify a telephone terminal to be connected of a session ID generated by the generator.

5. A telephone terminal connected to a private network or global network from which a communication packet is transmitted to a telephone exchange apparatus, comprising:
a generator configured to generate a session ID which is given to the communication packet when communication by the communication packet is started, wherein the session ID specifies a communication session to effect communication by the communication packet;
a notifying module configured to insert a session ID determined by the generator into a control signal to be sent when communication is started, and to notify the telephone exchange apparatus of the session ID; and
a controller configured to insert the session ID into all communication packets until the communication packet is stopped, when a response accepting the session ID notice is received from the telephone exchange apparatus.

6. The telephone terminal of claim 5, further comprising a refuser configured to cause the generator to generate a new session ID, when a response refusing the session ID notice is received from the telephone exchange apparatus.

7. The telephone terminal of claim 5, wherein the generator changes a session ID for each communication session established between telephone terminals to effect communication.

8. A control method used for a telephone system comprises a telephone terminal and a telephone exchange apparatus which is connectable to a network address translator (NAT) router through a private network, and establishes a communication session between telephone terminals, wherein the NAT router establishes connection between a private network connected to the telephone terminals and a global network provided in a wider area than the private network and connected to the telephone terminals, comprising:
establishing a communication session between a plurality of telephone terminals on the private network and a telephone terminal on the global network through a common port specifying the private network by a communication processor, in the telephone exchange apparatus;
storing a management table which associates a terminal ID specifying a telephone terminal to be connected, a session ID specifying a communication session, and an address and port ID specifying a network to be connected to the telephone terminal, for each session, in a memory, in the telephone exchange apparatus, when a communication session is established by the communication processor; and
referring to the management table based on a session ID included in a communication packet when a communication packet is received, and sending instruction data to the communication processor to effect communication by the communication packet between telephone terminals establishing a communication session, based on a reference result of the management table.

9. The method of claim 8, wherein the referring comprises determining whether a session ID included in a received communication packet is identical to a session ID in the management table, and the sending comprises sending instruction data to the communication processor to effect communication by the communication packet between telephone terminals establishing a communication session corresponding to the session ID when they are identical, and sending a message refusing reception of the communication packet to a telephone terminal which is a transmission source of the communication packet when they are not identical.

10. The method of claim 8, wherein the referring comprises extracting a session ID included in a header area of the communication packet, when the communication packet comprises the header area and a data area.

11. The method of claim 8, further comprising generating a session ID when a communication session is established, and notifying a telephone terminal to be connected of the session ID.

12. The method of claim 8, further comprising generating a session ID which is given to the communication packet in the telephone terminal when communication by the communication packet is started, wherein the session ID specifies a communication session to effect communication by the communication packet;
inserting the session ID into a control signal to be sent in the telephone terminal when communication is started, and notifying the telephone exchange apparatus of the session ID; and
inserting the session ID into all communication packets until the communication packet is stopped in the telephone terminal, when a response accepting the session ID notice is received from the telephone exchange apparatus.

13. The method of claim 12, further comprising generating a new session ID, when a response refusing the session ID notice is received from the telephone exchange apparatus.

14. The method of claim 12, wherein the generating comprises changing a session ID for each communication session established between telephone terminals to effect communication.
